(19) United States
(12) Patent Application Publication
(10) Pub. No.: US 2019/0027077 A1
(43) Pub. Date: Jan. 24, 2019

(54) ELECTRONIC DEVICE AND METHOD

(71) Applicants: Kabushiki Kaisha Toshiba, Tokyo (JP); Toshiba Visual Solutions Corporation, Aomori (JP)

(72) Inventor: Shiro Kudo, Kumagaya Saitama (JP)

(21) Appl. No.: 15/916,671

(22) Filed: Mar. 9, 2018

(30) Foreign Application Priority Data
Jul. 21, 2017 (JP) 2017-142212

(51) Int. Cl. G09G 3/00; G09G 3/20; H04N 9/04

(52) U.S. Cl. CPC G09G 3/007; G09G 2320/0261; H04N 9/045; G09G 3/2018

(57) ABSTRACT

According to one embodiment, electronic includes a determination module, and a controller. The controller configured to execute, for the image signal determined by the determination module as including the specific component, at least one of generating a second image signal which provides a display size greater than or equal to that defined by the image signal after reducing a horizontal display pixel number and a vertical display pixel number included in the image signal while maintaining a ratio of the horizontal display pixel number to the vertical display pixel number, and changing at least one of output timings of a horizontal output timing and a vertical output timing of the image signal.

### CROSS-REFERENCE TO RELATED APPLICATIONS

This application is based upon and claims the benefit of priority from Japanese Patent Application No. 2017-142212, filed Jul. 21, 2017, the entire contents of which are incorporated herein by reference.

### FIELD

Embodiments described herein relate generally to an electronic device and a method.

### BACKGROUND

As display modes of a display device which displays a screen image (video or a picture), a justscan mode and an overscan mode are known. The justscan mode displays video constituted of all the pixels included in a video signal such that the video fits in a display screen of the display device. The overscan mode displays the video on a larger scale as compared to that in the just scan mode by removing a peripheral portion of the video constituted of all the pixels included in the video signal.

Incidentally, when the display device is constituted of a self-luminous panel, such as an organic electro-luminescence (OLED), if a video signal which displays high-luminance video in the same position is input continuously, burn-in (screen burn) which stops a pixel of that portion from functioning is likely to occur. In order to reduce occurrence of the burn-in (that is, suppress occurrence of the burn-in), a process called pixel shift (image movement) is performed. The pixel shift is carried out to periodically change a display position of the entire video displayed on the panel.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of the essential parts of an electronic apparatus (a television broadcast receiver) according to an embodiment.

FIG. 2 shows an example of a display image in a just scan state before an image displayed by the electronic apparatus of the embodiment is subjected to overscanning display according to an embodiment.

FIG. 3 shows an example of the relationship between a position where the original image is cut out when the image displayed by the electronic apparatus of the embodiment is enlarged by the overscanning display and the display image according to an embodiment.

FIG. 4A shows an example of the relationship between a position where the original image is cut out when the image displayed by the electronic apparatus of the embodiment is enlarged by the overscanning display and the display image according to an embodiment.

FIG. 4B shows an example of the relationship between a position where the original image is cut out when the image displayed by the electronic apparatus of the embodiment is enlarged by the overscanning display and the display image according to an embodiment.

FIG. 4C shows an example of the relationship between a position where the original image is cut out when the image displayed by the electronic apparatus of the embodiment is enlarged by the overscanning display and the display image according to an embodiment.

FIG. 4D shows an example of the relationship between a position where the original image is cut out when the image displayed by the electronic apparatus of the embodiment is enlarged by the overscanning display and the display image according to an embodiment.

FIG. 5 is a flowchart showing an example of a method of displaying an image displayed by the electronic device according to an embodiment.

FIG. 6 is a flowchart showing an example of a method of displaying an image displayed by the electronic device according to an embodiment.

FIG. 7 is a flowchart showing an example of a method of displaying an image displayed by the electronic device according to an embodiment.

### DETAILED DESCRIPTION

In general, according to one embodiment, an electronic comprises: a determination module, and a controller. The configured to determine whether an image signal, which should be output to an output end, has luminance exceeding a predetermined level, and includes a specific component which is existent over a predetermined period. The controller configured to execute, for the image signal determined by the determination module as including the specific component, at least one of generating a second image signal which provides a display size greater than or equal to that defined by the image signal after reducing a horizontal display pixel number and a vertical display pixel number included in the image signal while maintaining a ratio of the horizontal display pixel number to the vertical display pixel number, and changing at least one of output timings of a horizontal output timing and a vertical output timing of the image signal.

Various embodiments will be described hereinafter with reference to the accompanying drawings.

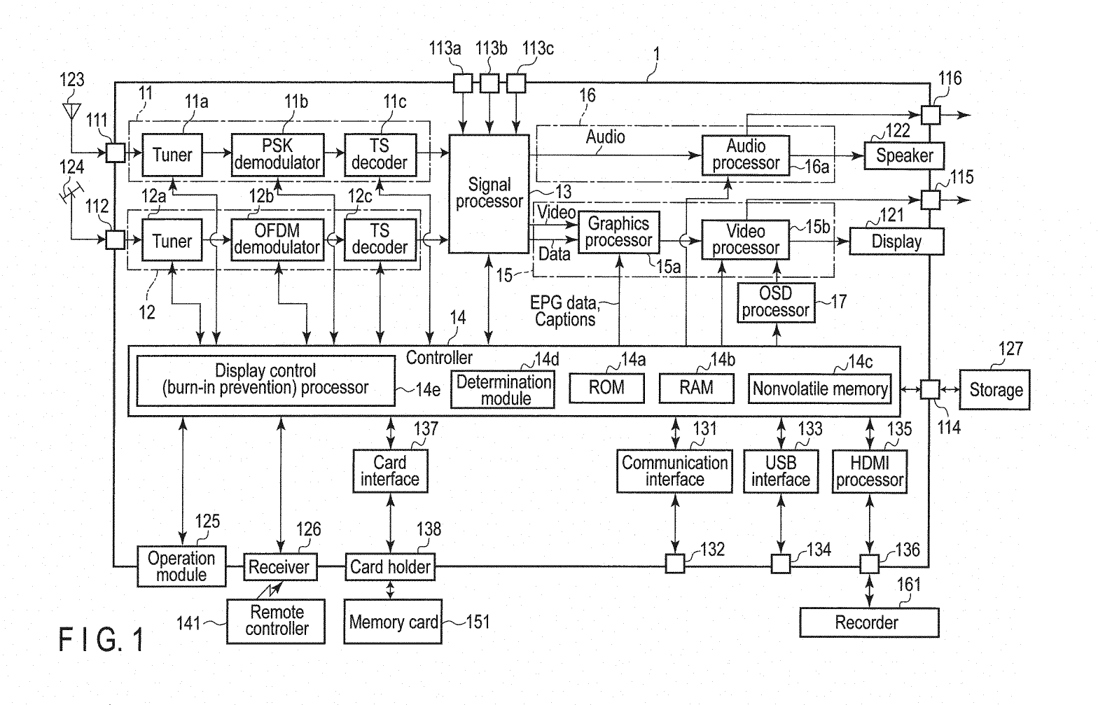

FIG. 1 shows an example of a schematic block diagram for explaining the essential parts of an electronic apparatus, such as a television broadcast receiver (which may also be referred to as a television apparatus), according to the present embodiment.

A television apparatus 1 shown in FIG. 1 receives and plays back a program, selected by a viewer (a user), of programs (which may also be referred to as content) supplied by signal transmission using space waves (which may also be referred to as a broadcast) or distribution through a network. Note that acquisition of a program may be made by accessing, for example, a content server (which may also be referred to as a program supplier) (i.e., by reference and selective acquisition (which may also be referred to as a download)).

Also, each of elements and structures described below may be realized by software using a microcomputer (a processor or a CPU [central processing unit]), or may be realized by hardware. Note that the program may be referred to as a stream or information, and is constituted of video and speech or music accompanying the video, etc. Further, video includes a moving image and a still image or text (information represented by, for example, a character indicated by a coded code string or a symbol), and an arbitrary combination of the aforementioned elements.

The television apparatus 1 includes a first receiving processor 11, a second receiving processor 12, a signal processor (a digital signal processor [DSP]) 13, a controller 14, an output video processor 15, an output acoustic processor 16, etc. An input terminal 111 and an input terminal 112 are connected to the first receiving processor 11 and the second receiving processor 12, respectively. A display (a display device) 121 and an acoustic reproducer (a speaker) 122 are connected to the output video processor 15 and the output acoustic processor 16, respectively. Preferably, the display 121 should be one which uses a self-luminous display panel such as an organic electro-luminescence (OLED) panel.

The first receiving processor 11 includes a tuner 11a, a phase shift keying (PSK) demodulator 11b, and a transport stream (TS) decoder 11c.

Based on control by the controller 14, the tuner 11a receives a broadcast wave from a broadcast satellite (BS) or communication satellite (CS) to which a satellite broadcasting antenna 123 connected to the input terminal 111 is tuned, that is, a BS/CS digital television broadcast signal.

Based on control by the controller 14, the PSK demodulator 11b demodulates the broadcast signal of a station selected by the tuner 11a, extracts the transport stream TS including a desired program, and outputs the extraction to the TS decoder 11c.

Based on control by the controller 14, the TS decoder 11c decodes the multiplexed transport stream TS, and depacketizes digital video and audio signals of the desired program. The TS decoder 11c also outputs a packetized elementary stream (PES) obtained by the depacketization to a system target decoder (STD) buffer, which is not shown, in the signal processor 13. The TS decoder 11c further outputs section information that is included in the broadcast signal to a section processor, which is not shown, in the signal processor 13.

The second receiving processor 12 includes a tuner 12a, an orthogonal frequency division multiplexing (OFDM) demodulator 12b, and a TS decoder 12c.

Based on control by the controller 14, the tuner 12a receives a broadcast wave of a terrestrial digital broadcast reception antenna 124 connected to the input terminal 112 is tuned, more specifically, the so-called terrestrial digital television broadcast signal.

Based on control by the controller 14, the OFDM demodulator 12b demodulates the broadcast signal of a channel selected by the tuner 12a, extracts the transport stream TS including the desired program, and outputs the extraction to the TS decoder 12c.

Based on control by the controller 14, the TS decoder 12c decodes the multiplexed TS, and depacketizes digital video and audio signals of the desired program. The TS decoder 12c also outputs a PES obtained by the depacketization to the STD buffer, which is not shown, in the signal processor 13. The TS decoder 12c further outputs section information that is included in the broadcast signal to the section processor, which is not shown, in the signal processor 13.

The section processor, which is not shown, included in the signal processor 13 outputs various kinds of data for receiving (acquiring) an arbitrary program from among items of section information from the TS decoder 11c or 12c, at the time of an activation process or at a predetermined timing to the controller 14. One item of data includes key information (and a predetermined kind of information (reception permission) held in a card medium) for descrambling for unlocking a scramble by a conditional access system (CAS): restricted reception. Another item of data includes, for example, service information SI including information such as electronic program guide (EPG) information, program attribute information regarding a program category, etc., and caption information. The service information SI includes program specific information (PSI), which is the information specifying to which program an elementary stream (ES) corresponding to each item of encoded image data and audio data included in the transport stream TS belongs.

Note that the above description relates to transfer of data such as the key information for the CAS descrambling between the section processor and the controller 14, the SI including the caption information, etc., the program attribute information, and the EPG information, and the PSI. This can be expressed as the controller 14 reading various kinds of data from the section processor at a predetermined timing.

When a program being received (a program of the on air) is viewed, the signal processor 13 selectively performs predetermined digital signal processing on the video signal and audio signal output from the TS decoder 11c or the TS decoder 12c, and outputs the processed signals to a graphics processor 15a of the output video processor 15 and an audio processor 16a of the output acoustic processor 16.

When a program being received is to be recorded, the signal processor 13 records a recording signal, which is obtained by selectively performing a predetermined digital signal processing on the video signal and audio signal output from the TS decoder 11c or the TS decoder 12c, to a storage (for example, a hard disk drive [HDD]) 127 connected through an input/output module 114 of the controller 14, on the basis of control by the controller 14. When the recorded program is to be played back, the signal processor 13 performs a predetermined digital signal processing on data of the recorded program, which has been read from the storage 127 via the controller 14, on the basis of the controller 14, and outputs the processed signals to the graphics processor 15a and the audio processor 16a.

The signal processor 13 also accepts an external input signal from various external devices through input terminal 113a, 113b, or 113c. The external device is arbitrary such as a set-top box (STB) (which may also be referred to as an external tuner), a video recording and reproduction apparatus (which may also be referred to as a recorder), a video reproduction apparatus (which may also be referred to as a player), or a video camera apparatus. In particular, the video camera apparatus is not limited to a form of a camera device, but may be a portable terminal device capable of capturing an image, such as a tablet personal computer (PC) device or a smartphone.

The signal processor 13 decodes digital (or analog) video and audio signals input from the input terminal 113a, 113b, or 113c, and performs processing for achieving high-resolution image and high-quality sound based on the user's request. Note that when the input signal input from the input terminal 113a, 113b, or 113c is an analog signal, analog-to-digital (A-D) conversion is performed via an analog-to-digital (A-D) conversion circuit not shown, also.

The controller 14 includes process circuitry such as a micro processing unit (MPU) or a central processing unit (CPU), and controls the operation of each part of the television apparatus 1. The controller 14 also includes a read-only memory (ROM) 14a, a random-access memory (RAM) 14b, a nonvolatile memory (NVM) 14c, a determination module (a burn-in factor detector) 14d, and a display control (burn-in prevention) processor 14e, etc.

For example, when the television apparatus 1 is powered on (i.e., at the time of user operation input by a remote controller 141), the controller 14 operates an activation processing program held in the ROM 14a on the RAM 14b, and executes a predetermined initial operation (the activation process). Also, the controller 14 executes a predetermined process with a RAM 14b used as a work memory based on control by a CPU or a MPU which operates in accordance with a control program held in a ROM 14a. The NVM 14c holds various kinds of setting information, control information, or the like.

The controller 14 acquires various kinds of data such as the key information for the CAS descrambling, the service information SI including the caption information, etc., the program attribute information, and the EPG information (EPG data), and the PSI from the signal processor 13 at the time of the activation process or at a predetermined timing. The controller 14 also performs an image generation process for displaying the EPG and captions of the information acquired from the signal processor 13, and outputs the EPG data and captions information corresponding to the EPG and captions to the graphics processor 15a of the output video processor 15.

The controller 14 further determines whether the video signal “Video” (indicated in FIG. 1) and image data independent of the “Video” or a character component “Data” (indicated in FIG. 1) including a specific component (which may also be referred to as a factor pixel). The “Video” or the “Data” output from an audio/video decoder (an AV decoder), e.g. software decoder included in the signal processor 13 or program for decoding stored in a firm of the signal processor 13 to the graphics processor 15a. More specifically, the determination module 14d included in the controller 14 detects whether the “Video” or the “Data” output by the AV decoder of the signal processor 13 to the graphics processor 15a include the specific component. The result of the determination that the specific component is included in the “Video” or the “Data” is held by the controller 14.

The factor pixel (specific component) is intended as a luminance component of an image signal input to the display 121 having the intensity greater than a predetermined level, and a continuous display period for this luminous component is longer than a predetermined period. Note that the continuous display period can be counted (managed) by the number of frames since a display target image extends over a plurality of frames in most cases.

The factor pixel is mostly a mark for weather information or temperature indication, for example, time indicating, or emergency information (alert), or character superimposition. The factor pixel may be a logo or an icon representing the content supplier (i.e., the broadcasting station (channel)), for example, a program name (program logo), etc. An icon or device name indicating for selection of various kinds of content to be input to the television apparatus 1 via an HDMI processor 135, a USB interface 133, a communication interface 131, or the input terminal 113a, 113b, or 113c also corresponds to the factor pixel.

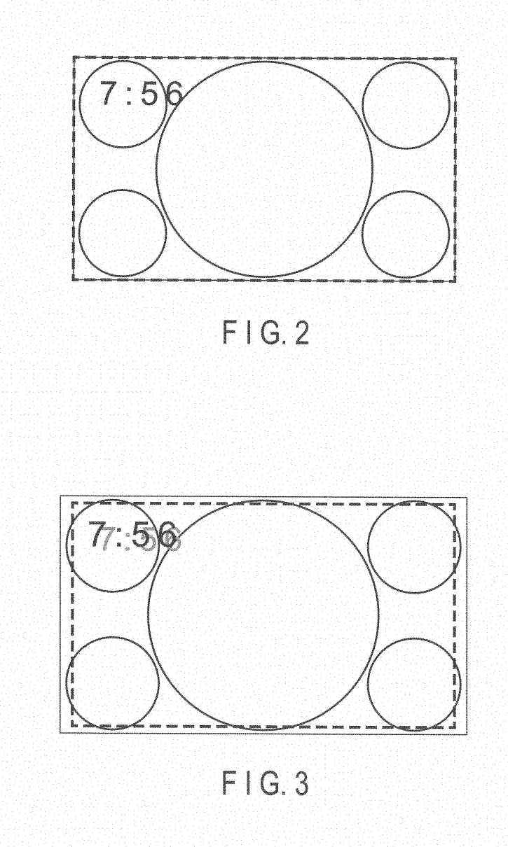

When the determination module (the burn-in factor detector) 14d detects the factor pixel (specific image), the display control (burn-in prevention) processor 14e performs a burn-in reduction process for the “Video has been included the factor pixel” (which may also be referred to as “video”) and “Data has been included the factor pixel” (which may also be referred to as “data”) for which the factor pixel has been detected. The burn-in reduction process will be described in detail later referring to FIGS. 2, 3, 4A, 4B, 4C, 4D, 5, 6, and 7.

The controller 14 also controls program recording and program timer recording. At the time of accepting the program recording reservation, the controller 14 outputs a display signal for displaying the EPG on the display (display module) 121 to the graphics processor 15a. The controller 14 also sets (stores) the reservation details based on the operation input (user instruction) through a remote controller 141 or an operation module 125 in predetermined storage for example, the NVM 14c.

When the set time nearly arrives, the controller 14 controls the first reception processor 11 (the tuner 11a, the PSK demodulator 11b, and the TS decoder 11c) or the second reception processor 12 (the tuner 12a, the OFDM demodulator 12b, and the TS decoder 12c), and the signal processor 13 so as to record a reserved program at the set time.

The controller 14 connects with a LAN terminal 132 via the communication interface 131, and information is exchanged between the controller 14 and an arbitrary LAN-capable device connected to the LAN terminal 132, also. The communication interface 131 realizes radio communication with a short-range wireless communication device conforming to, for example, the Wireless Fidelity (Wi-Fi) standard. As the short-range wireless communication standard, Bluetooth (registered trademark) standard and Near Field Communication (NFC), for example, can also be used. The communication interface 131 can also directly communicate with a tablet terminal (a smartphone or a portable personal computer [PC]), for example.

The controller 14 connects with a USB terminal 134 via the USB interface 133 conforming to the Universal Serial Bus (USB) standard, and information is exchanged between the controller 14 and various USB devices (for example, a USB-connected HDD or memory card) operating under the USB standard which are connected to the USB terminal 134, also.

The controller 14 connects to an HDMI terminal 136 via the HDMI processor 135 conforming to the High-definition Multimedia Interface (hereinafter abbreviated as HDMI (registered trademark)) standard. In this way, the controller 14 can exchange information (video signal, audio signal and control signal) with an arbitrary HDMI-capable device connected to the HDMI terminal 136. For example, when an acoustic reproducing apparatus capable of receiving an acoustic signal (“Audio”) via the HDMI processor 135 is connected to the HDMI terminal 136, independently of the speaker (or such that it can be used together with the speaker 122 or switched from the speaker 122), a sound and speech can be reproduced in a sound field or a reproduction condition provided by the acoustic reproducing apparatus.

The controller 14 connects to a card holder 138 in which a memory card 151 can be mounted via a card interface 137, and information is exchanged between the controller 14 and the memory card 151 via the card holder 138.

The controller 14 can include a Dynamic Host Configuration Protocol (DHCP) server function as firmware of the MPU (CPU) or an application (program) which can be acquired through a network, also. When the controller 14 includes the DHCP server function, information (program/content) can be exchanged with a LAN (local area network)-capable external device, such as the other device (another television apparatus, etc.) conforming to the Digital Living Network Alliance ([DLNA] (registered trademark) standard.

The graphics processor 15a synthesizes the “Video” and “Data” output by the AV decoder of the signal processor 13 and the EPG data and captions information corresponding to the EPG and captions created by the controller 14, and outputs the synthesized data to a video processor 15b. When captions are to be displayed in a subtitled broadcast or live captions are to be displayed by adding captions to the speech or conversation in a program on the air, the graphics processor 15a also performs a process of superimposing caption information on the video signal (to create captioned video) on the basis of control by the controller 14.

The video processor 15b converts a display video signal, which is obtained by superimposing of the “Video” and “Data” from the graphics processor 15a and the EPG and captions, into a real display signal in a format that the display 121 or an external device connected via an output terminal 115 can display, and outputs such a converted signal (the real display signal) to the display 121 or the output terminal 115. The video processor 15b also superimposing a volume bar image for changing a volume level, for example, corresponding to the user operation (control input), or an on-screen display (OSD) signal created by an OSD processor 17, such as menu screen display for menu selection, for example, into the display video signal from the graphics processor 15a. In that case, when the OSD signal created by the OSD processor 17 is presented, the real display signal is replaced with a signal into which the OSD signal is integrated.

The acoustic processor 16 converts a digital audio signal from the signal processor 13 into an analog audio signal in a format which can be produced by the speaker 122, and outputs the converted analog audio signal to the speaker 122 or an external device connected via an output terminal 116 such as an acoustic reproducing apparatus (for example, a multichannel speaker system). Note that when the acoustic reproducing apparatus can receive the acoustic signal (“Audio”) via the aforementioned HDMI terminal 136, the acoustic reproducing apparatus may be connected to the HDMI terminal 136.

Next, the burn-in reduction process will be described in detail.

From the intensity of a luminance component of the image signals including “Video”, “Data”, and the EPG data, captions information corresponding to the EPG and captions created by the controller 14, which become the source of the real display signal corresponding to the display image displayed on the display 121, the determination module (burn-in factor detector) 14d of the controller 14 detects the factor pixel (specific image), and determines the burn-in factor. The intensity of the luminance component of the image signal can be replaced with a current value (magnitude) of a drive current value which is highly associated with the luminance component of the image signal corresponding to the image displayed by pixels.

When the display 121 is a self-luminous display, it is known that if an image is displayed longer than a certain period based on the image signal corresponding to the factor pixel, a pixel displaying that image no longer functions as it should be such as the contour or display color being fixed in the later display. The above phenomenon is called screen-burn (burn-in).

Accordingly, when it is determined that a determination result of the detection includes the factor pixel (burn-in factor) from the intensity of the luminance component of the image signal described above, preferably, the display control (burn-in prevention) processor 14e should perform the burn-in reduction process for either one or both of the display video signal from the graphics processor 15a and the video signal output from the signal processor 13, which become the source of the real display signal that the video processor 15b outputs to the display 121 or the output terminal 115.

The determination module 14d detects an image including an image signal in which the magnitude (intensity) of the luminance component of the image signal corresponding to a pixel at an arbitrary position of a target image of one frame or respective pixels of a group of pixels constituted of arbitrary pixels located around or near that pixel is greater than or equal to a certain level. The determination module 14d determines the image signal output longer than the certain period (the number of frames exceeding a predetermined number) in which the intensity (magnitude) of the luminance component is greater than or equal to a certain level as the factor pixel (burn-in factor). The image signal corresponding to a pixel determined as being the factor pixel is often an image signal whose display position is substantially fixed on the display 121. That is, the image signal corresponding to a pixel determined as being the factor pixel is often that of a high-luminance still image which hardly moves within the display image for each frame.

Note that the factor pixel can be extracted in units of one image signal corresponding to each pixel by, for example, a pattern analysis technology, a noise area analysis technology, and a master refinement technology. Further, when the factor pixel is to be determined, the length of a period for detecting that the continuous display period exceeds a certain range (i.e., the length of a total display period) should preferably cover all of the images in which the intensity of a luminance signal (or the current value (magnitude) of a drive current which is highly associated with the luminance component of the image signal) is greater than or equal to a certain level, although their display colors are different, for example.

When a determination result by the determination module 14d shows that the burn-in factor is included (that is, when it is determined that the pixel corresponds to the factor pixel), the display control (burn-in prevention) processor 14e performs the burn-in reduction process for either one or both of the display video signal from the graphics processor 15a and the video signal (EPG and/or captions) output from the signal processor 13.

Specifically, the burn-in reduction process is a process for adding a component which changes the display position of a real display signal (which may also be referred to as a second image signal) on the display 121 to the display signal that the video processor 15b outputs to the display 121 or the output terminal 115.

In the burn-in reduction process, the position of displaying on the display 121 related to the real display signal can be realized by changing the position information of the pixel (or pixel group) of the display signal such that an image determined as including the factor pixel is displayed by using a separate pixel (or pixel group), which is different from the pixel (or pixel group) at a position which should have been displayed, and is distant by a predetermined number of pixels.

The position of displaying of the real display signal on the display 121 can be provided by at least one of or a combination of, for example, the enlargement (overscanning) of the image and the pixel shift (image movement).

The overscanning is to provide the real display signal in which pixel components (the number of pixels) in a horizontal direction and pixel components (the number of pixels) in a vertical direction are reduced to a number of the reciprocal multiple of the requested enlargement scale while maintaining the ratio (i.e., the aspect ratio of the lateral pixel component and the vertical pixel component), and the pixel components of that number are enlarged to perform display with all the pixels on the display 121. In contrast, a justscan (justscanning) in which the real display signal corresponds to all the pixels are displayed with the original positional relationship (and/or the scale of enlargement). That is, to display the image in the justscan mode, the pixels of the real display signal are in a 1:1 relationship to the pixels with the display 121 in specific.

That is, the burn-in prevention process is performing the following for the image signal determined by the determination module 14d as including the specific component: (i) reducing the horizontal display pixel number and the vertical display pixel number included in the image signal while maintaining the ratio of the horizontal display pixel number to the vertical display pixel number; (ii) generating the second image signal (real display signal) which provides the display size greater than or equal to the display size defined by the image signal; and (iii) changing at least one of output timings of a horizontal output timing and a vertical output timing of the second image signal which has been generated.

Note that the changing of at least one of the output timings of the horizontal output timing and the vertical output timing may be executed before the second image signal is generated. Also, the generation of the second image signal and the change of the output timing may be executed alternately such as changing the output timing for one pixel and reducing the pixel number included in the second image signal by one step, and then changing the output timing for one pixel and reducing the pixel number included in the second image signal by one step.

Alternatively, reducing each of the horizontal pixel component and the vertical pixel component at a requested reduction ratio, as compared to the justscanning, is also possible as the burn-in reduction process so that this can be the opposite process of the overscanning. However, in this case, it is obvious that an image displayed on the display 121 will have a non-image area, and thus, this process is not practical.

Further, the technique of changing the position information of the pixel (or pixel group) is arbitrary such as changing a read timing when the real display signal is output to the graphics processor 15a from the RAM 14b, and inserting margin data when the real display signal is developed on the RAM 14b. Furthermore, in a case where the horizontal pixel number of the display 121 is 1920 pixels and the vertical pixel number of the same is 1080 pixels, for example, it is needless to say that a case where an image signal is displayed by down-converting the image signal including 3840 horizontal pixel components and 2160 vertical pixel components of the real display signal into 1920 pixels and 1080 pixels, respectively, also corresponds to the display of the justscanning.

Note that, the justscanning may be referred to as displaying of video constituted of all the pixels included in the video signal such that the video fits in a display screen of the display device. Also, the overscanning may be referred to as displaying the video on a larger scale as compared to that in the justscanning by removing a peripheral portion of the video constituted of all the pixels included in the video signal.

First, referring to FIGS. 2 and 3, an example of displaying an image by enlargement (overscanning) is shown. Note that in each of FIGS. 2 and 3, a range indicated by a dotted line corresponds to the maximum display range of the display 121. Further, in each of FIGS. 2 and 3, display in gray is assumed as the factor pixel. Meanwhile, in each of FIGS. 2 and 3, (slightly) enlarged display shown in black represents a display image to be displayed at a display position defined by the burn-in reduction process (i.e., the state in which the real display signal for which the burn-in reduction process has been performed is displayed on the display 121).

The enlargement of the image is realized by switching the display from the justscanning (FIG. 2) to the overscanning of enlarging the image signal corresponding to the image to be displayed at a predetermined magnification and displaying the image, as shown in FIG. 3. However, in the overscanning, part of the image displayed in the justscanning cannot be displayed.

More specifically, the display in the overscanning shown in FIG. 3 by the dotted line shows a range narrower than an area displayed in the justscanning shown in FIG. 2 by the dotted line before the overscanning is started. Accordingly, when the image is to be enlarged by the overscanning, it should preferably be avoided that an area including an image easily recognized by the viewer (user), such as an image represented by the factor pixel, is prohibited from being displayed. For example, when the overscanning is to be started, an image signal corresponding to the image should preferably be enlarged toward the four corners at a fixed ratio with the image signal corresponding to the image (pixel) located at substantially the center of the display screen being the substantial enlargement center.

In the overscanning, a display position (position information) of the real display signal including individual pixels of the image signal, which corresponds to an image determined by the determination module (the burn-in factor detector) 14d as including the factor pixel, is changed to a position determined as a result of enlargement by a predetermined number of steps in unit of pixel or pixels.

A change quantity for changing the position information is prepared (set) by the display control (the burn-in prevention) processor 14e in accordance with a prescribed rule to be described later. The change quantity of the position information is superimposed on at least one of, for example, the real display signal that the video processor 15b outputs to the display 121, the display video signal from the graphics processor 15a, and the Video (video) and/or Data (data) output from the signal processor 13, which become the source of the real display signal.

Note that changing the change quantity of the position information by the predetermined number of steps in unit of pixel or pixels can prevent partial discoloration, color shift, or the like, in an image process which may result from division of pixels (extension across pixels) from occurring. Also, a similar advantage can be obtained by making a setting such that the number of pixels increased in each of the steps becomes an integral multiple of the pixels.

In this way, it is possible to reduce the possibility of the viewer (user) recognizing that a magnification of an image being displayed is changing (i.e., the image is being enlarged over time). For example, when the horizontal pixel number of the display 121 is 1920 pixels and the vertical pixel number of the same is 1080 pixels, the scale of enlargement can be set on an approximately one percent basis (a little over 0.8%) by enlarging the image by 16 pixels horizontally and 9 pixels vertically in each step.

Note that in order to suppress occurrence of burn-in, it is effective to increase the scale of enlargement per unit time. Also, in order to reduce the possibility of the viewer (user) recognizing a change in the display image, the enlargement speed (time interval for executing each step) when the image is enlarged should preferably be, for example, several tens of seconds to several minutes (one to two minutes in order to obtain high burn-in prevention effect).

Further, in order to reduce the possibility of the viewer (user) recognizing that the magnification of the image being displayed is changing (the image is being enlarged over time), the image should preferably be enlarged at such timings that a commercial message (CM) is finished and a program is switched back to the main program, a segment (scene) of the main program is switched, sports video, etc., is switched to weather information, etc., and studio video is switched to relay broadcast video, etc. Also, preferably, the user should be able to arbitrary set the scale of enlargement per step and/or the enlargement ratio which should be the upper limit from a setting screen or the menu screen display.

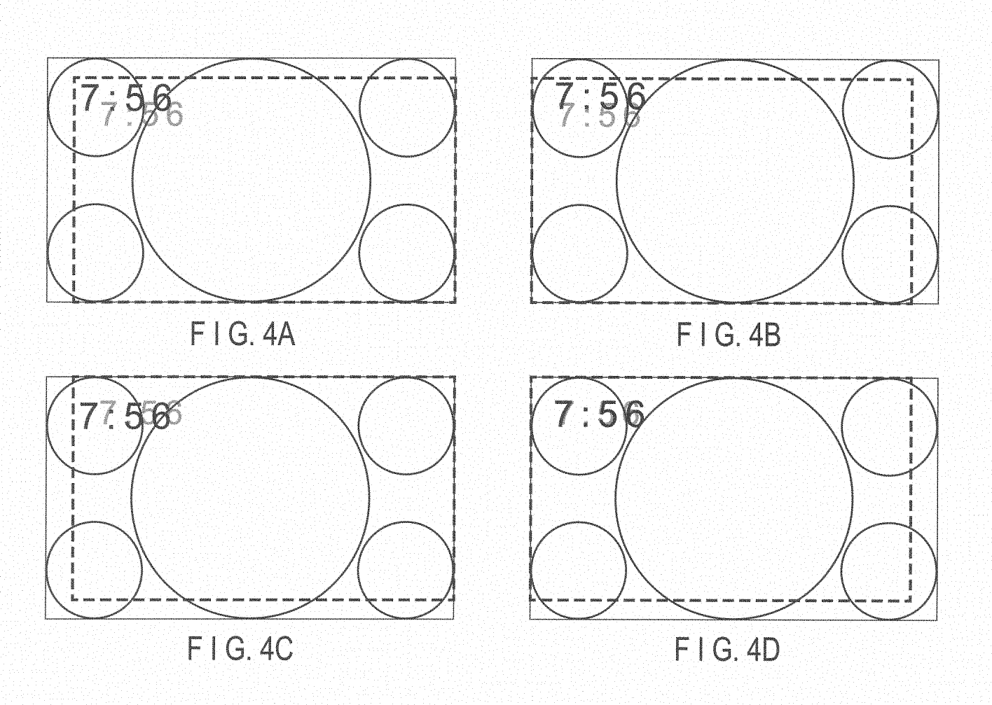

Next, referring to FIGS. 4A, 4B, 4C and 4D, a display example in which a pixel shift is applied is shown. Note that in each of FIGS. 4A, 4B, 4C and 4D, a range indicated by a dotted line corresponds to the maximum display range of the display 121. Further, in each of FIGS. 4A, 4B, 4C and 4D, display in gray is assumed as the factor pixel. Also, in each of FIGS. 4A, 4B, 4C and 4D, it is assumed that display shown in black represents a display image to be displayed at a display position defined by the burn-in reduction process (i.e., the state in which the real display signal for which the burn-in reduction process has been performed is displayed on the display 121).

The pixel shift can easily be realized by moving the display by the justscanning in an arbitrary direction at a predetermined timing as shown in FIGS. 4A, 4B, 4C and 4D. However, by moving the image displayed on the display 121 in the arbitrary direction, a part of the image displayed in the justscanning cannot be displayed. Accordingly, when the image displayed on the display 121 is to be moved in the arbitrary direction, movement in the direction of disabling display of an area including the image visually recognized by the viewer (user) easily, such as the factor pixel, should preferably be avoided.

Further, as regards the factor pixel, it is preferable that a display position of an image to be displayed by the pixel shift movement should not overlap the original display position of the image. More specifically, as shown in FIG. 2, for example, when it has been detected that the factor pixel is located at a position corresponding to the upper left part of the display 121, an image void portion, i.e., a portion in which the image is no longer displayed by the movement of the image, is determined to the image displayed in the upper left area of the display 121, as shown in FIG. 4A.

In this way, it is possible to enhance the effect of the burn-in reduction process by the pixel shift. Note that the pixel shift should preferably be performed such that the image display position returns to the original position in a fixed cycle. For example, movement should preferably be based on a movement locus similar to the locus of the infinity sign “∞” or the locus of the number “8”. Also, in order to reduce the possibility of the viewer (user) recognizing a change in the display image, the number of pixels to be moved per step should preferably be one. In this way, it is possible to reduce the possibility of the viewer (user) recognizing that the image being displayed is moving.

However, since the pixel shift is also cutting of a part of the image displayed on the display 121, the enlargement ratio (the ratio between the image enlarged at the maximum scale and the original image) and the maximum shift quantity of the pixel shift should preferably be suppressed to, for example, 10%. Further, in order to reduce the possibility of the viewer (user) recognizing a change in the display image, the movement speed when the pixel shift is performed should preferably be, for example, several tens of seconds to several minutes (one to two minutes in order to obtain high burn-in prevention effect) in one step.

Furthermore, in order to reduce the possibility of the viewer (user) recognizing that the position of the image being displayed is changing (the image is moving over time), the image should preferably be shifted (i.e., pixel shift should preferably be performed) at such timings that a commercial message (CM) is finished and a program is switched back to the main program, a segment (scene) of the main program is switched, sports video, etc., is switched to the weather information, etc., and studio video is switched to relay broadcast video, etc.

As a matter of course, when the factor pixel is no longer detected, it is also possible to restore the image subjected to enlargement or pixel shift at the aforementioned timing to the original state in a greater number of steps, not limited to the one-step procedure as described above. Preferably, the user should be able to arbitrary set the number of pixels to be moved per step and/or the maximum movement (number of pixels) from a setting screen or the menu screen display.

Note that the image enlargement or pixel shift of the display control (burn-in prevention) processor 14e may be executed by hardware or by software. Also, preferably, the user should be able to arbitrary set any one of the “justscan” mode, the “overscan” mode, and the “burn-in reduction (image enlargement and pixel shift)” mode, for example, from the setting screen or the menu screen display.

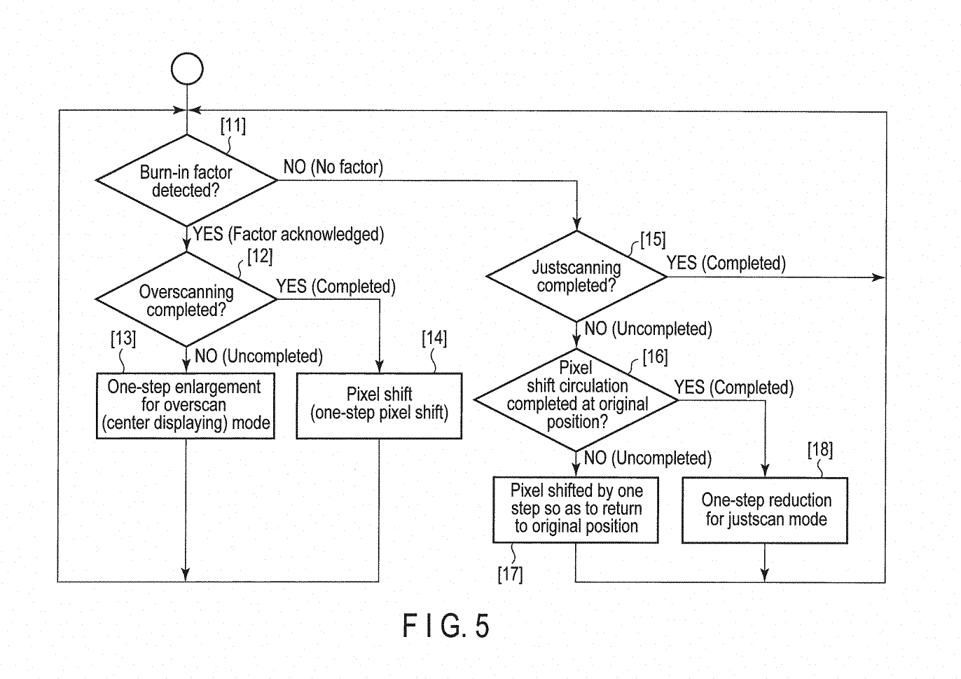

FIG. 5 shows an example in which the image enlargement shown in FIG. 3 and/or the pixel shift shown in FIGS. 4A, 4B, 4C and 4D are applied, as software. Note that the example shown in FIG. 5 assumes a case where a position at the time of starting of the overscan (center displaying) mode is set to the display position represented by a signal corresponding to the central image (or the nearby the central image) related to the real display signal.

When the burn-in factor (factor pixel) is detected in a state in which a program (content) is reproduced based on the justscan (mode) display (YES in block 11 [factor acknowledged]), to start the overscan (mode) display (block 12). Until the image enlargement by the overscanning reaches the predetermined magnification (NO in block 12 [overscanning uncompleted]), the overscanning is performed by one step (block 13).

When the image enlargement by the overscanning reaches the predetermined magnification (YES in block 12 [overscanning completed]), the pixel shift is performed by one step (block 14).

In this way, when it is detected that a still image, which constitutes a burn-in factor (image) including a high-luminance image signal, for example, exists in an image included in a program being reproduced (displayed), the display position of a pixel which becomes the burn-in factor is changed by enlargement of the image, and the display position of the entire image on the display is further changed. Consequently, it is possible to prevent the screen-burn (burn-in) from occurring at a specific pixel in the display.

Meanwhile, when the burn-in factor (factor pixel) is no longer detected from the program (content) being reproduced (NO in block 11 [no factor]), if a change of the (image) display position which is to be returned to the justscan mode has still not been completed (i.e., if the process is NO in block 15), until the display position of the image moved by the pixel shift returns to its original display position (i.e., if the process is still NO in block 16 [pixel shift circulation completed at the original display position?]), the display position of the image moved by the pixel shift one step at a time is moved such that it is headed toward the original display position one step at a time (block 17).

Once the change made to the display position of the image by the pixel shift has been counterbalanced (YES in block 16 [pixel shift circulation completed at the original position?]), the display position of the image is changed one step at a time so that the display is returned to the justscan mode (block 18).

More specifically, when the image signal corresponding to the image to be displayed includes the burn-in factor (YES in block 11 [factor acknowledged]), it is confirmed whether the overscanning is completed (block 12). If the overscanning is uncompleted (NO in block 12), first, the processing is gradually shifted (i.e., changed step by step) from the “justscan” to the “overscan (center displaying) mode (a position at the time of starting of the overscan (center displaying) mode)” (block 13).

After the overscanning has been completed (YES in block 12), to start the pixel shift (block 14). Note that by ensuring that the overscanning (enlargement of the image by the overscanning up to the predetermined magnification) and the pixel shift are both executed in multiple steps, and the time taken is ten-odd seconds to several minutes in each step, it is possible to suppress an image breakage (an image shock) caused by the magnification or the display position of the image being displayed changed suddenly.

Also, when the burn-in factor (factor pixel) is no longer detected in the middle of performing the overscanning and the pixel shift (NO in block 11), justscanning is performed after the pixel shift circulation process has been finished (blocks 16 to 18, and block 15).

More specifically, whether or not the burn-in factor is detected is checked (block 11), and when no factor is found (NO in block 11), it is confirmed whether the justscanning is completed (block 15). If the justscanning is completed (YES in block 15), since the display is returned to normal display, the control is finished.

If the justscanning is uncompleted (NO in block 15), it is confirmed whether the pixel shift circulation process is completed, i.e., the display point has returned to the original position (block 16), and if the pixel shift circulation process is uncompleted (NO in block 16), the (display) position of the image being displayed is repositioned so that the pixel shift circulation process can be completed (block 17), and the processing is gradually shifted to the overscan (center displaying).

Meanwhile, if the pixel shift circulation process is completed (YES in block 16), the processing is gradually shifted (changed step by step) from the overscan (center displaying) to the justscan mode (block 18).

Note that FIG. 5 illustrates that of the overscanning and the pixel shift, the overscanning is first executed, and the pixel shift is executed after completion of the overscanning. However, the two may be executed alternately, or the pixel shift may be executed former to the overscanning, for example. Further, one of the above two processes may be executed continuously for two steps or more, or both of the two may be executed for multiple steps.

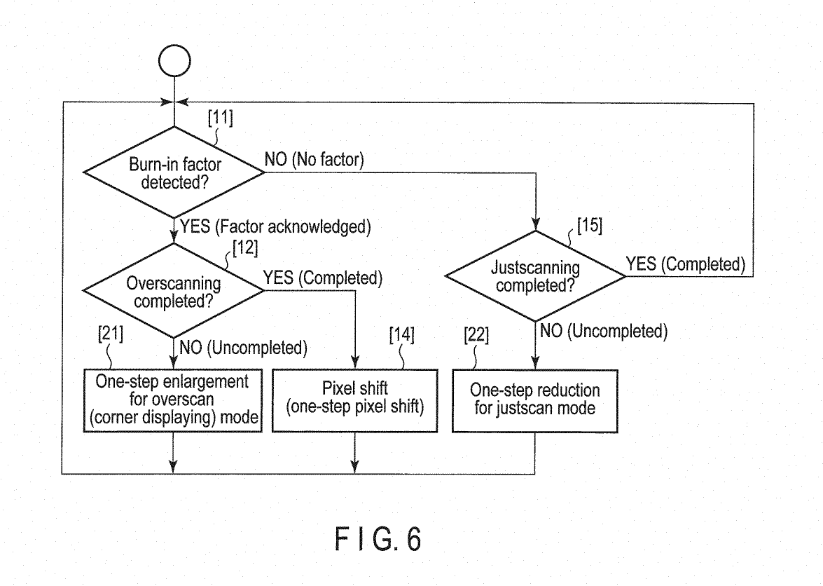

FIG. 6 shows an example in which the image enlargement shown in FIG. 3 and/or the pixel shift shown in FIGS. 4A, 4B, 4C and 4D are applied, as software. Note that the example shown in FIG. 6 assumes a case where one of four corners, a distance of which is great from the display position represented by a signal corresponding to an image in which the factor pixel (burn-in factor) is detected, is set to the starting position of the overscan (corner displaying) mode.

The burn-in factor (factor pixel) detection is confirmed (block 11) in a state in which a program (content) is reproduced with the justscan (mode) display, and when the factor is acknowledged (YES in block 11), it is confirmed whether the overscanning is completed (block 12).

If the overscanning is uncompleted (NO in block 12), the display is gradually shifted from the justscan mode to the overscan mode (block 13).

If the overscanning is completed (YES in block 12), to start the pixel shift (block 14).

If the burn-in factor is no longer detected in the partway of performing the overscanning/the pixel shift (NO in block 11), justscanning is gradually performed from the present display position to which the pixel shift is applied (block 15).

More specifically, whether or not the burn-in factor is detected is checked (block 11), and when no factor is found (NO in block 11), it is confirmed whether the justscanning is completed (block 15). If the justscanning is completed (YES in block 15), since the display is returned to normal display, nothing is performed (control finished). If the justscanning is uncompleted (NO in block 15), justscanning is gradually performed from the present display position (block 22).

More specifically, in the example illustrated in FIG. 6, when the burn-in factor is no longer detected, the state in which the pixel shift is applied is brought to an end without returning the display position in the overscan mode to the center. In this way, as compared to the example explained referring to FIG. 5, it becomes possible to more speedily shift the display to the justscan mode, which is the ordinary viewing state (i.e., restore the display to the original state).

Note that the example illustrated in FIG. 6 has also been described that, of the overscanning and the pixel shift, the overscanning is first executed, and the pixel shift is executed after completion of the overscanning. However, the two may be executed alternately, or the pixel shift may be executed former to the overscanning, for example. Further, one of the above two processes may be executed continuously for two steps or more, or both of the two may be executed for multiple steps.

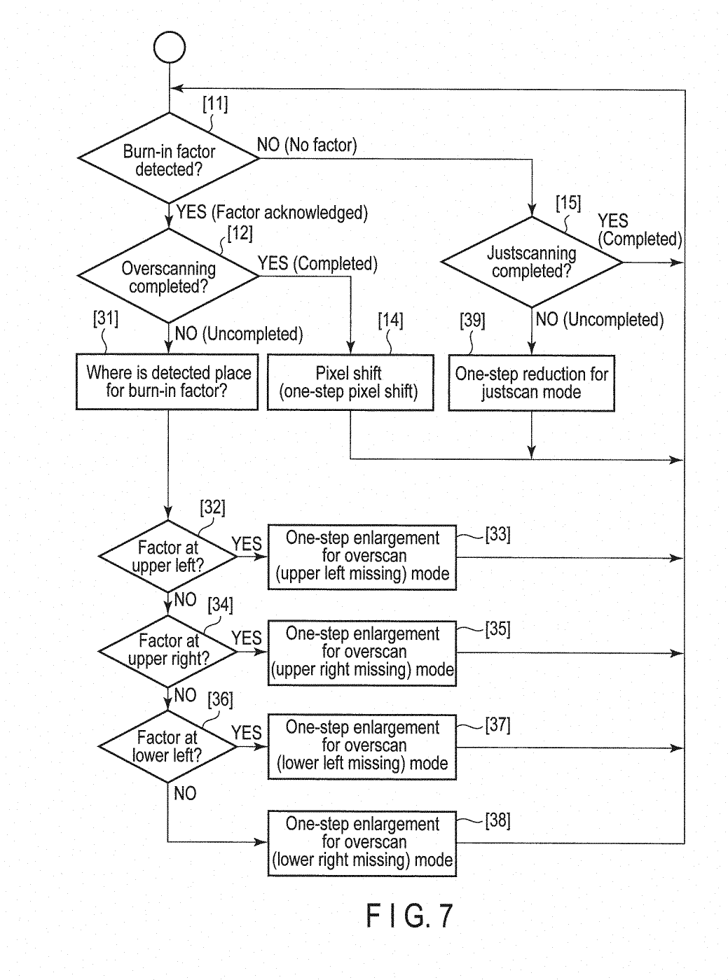

FIG. 7 shows an example in which the image enlargement shown in FIG. 3 and/or the pixel shift shown in FIGS. 4A, 4B, 4C and 4D are applied, as software.

The burn-in factor (factor pixel) detection is confirmed (block 11) in a state in which a program (content) is reproduced with the justscan mode display, and when the factor is acknowledged (YES in block 11), it is confirmed whether the overscanning is completed (block 12).

If the overscanning is uncompleted (NO in block 12), the display is gradually shifted from the justscanning to the overscanning. At this time, when the display is shifted from the justscanning to the overscanning on the basis of a detection place at which the burn-in factor (factor pixel) is detected, a direction in which the overscanning is started is changed (Where is detected place for burn-in factor?[block 31]).

For example, when the burn-in factor (factor pixel) is detected from an image signal corresponding to the upper left part of the screen display as shown in FIG. 2 (YES in block 32), pixel shift is performed by determining an image void portion, i.e., a portion in which the image is no longer displayed by the overscanning (and the movement of the image), to the image displayed in the upper left area of the display 121 as shown in FIG. 4A (block 33). When a position at which the burn-in factor (factor pixel) is detected is, for example, the upper right part (YES in block 34), pixel shift is performed by determining the image void portion, i.e., the portion in which the image is no longer displayed by the overscanning (and the movement of the image), to the image displayed in the upper right area of the display 121 as shown in FIG. 4B (block 35).

When a position at which the burn-in factor (factor pixel) is detected is, for example, the lower left part (YES in block 36), pixel shift is performed by determining the image void portion, i.e., the portion in which the image is no longer displayed by the overscanning (and the movement of the image), to the image displayed in the lower left area of the display 121 as shown in FIG. 4C (block 37).

Accordingly, when a position at which the burn-in factor (factor pixel) is detected is, for example, the lower right part (NO in block 36), pixel shift is performed by determining the image void portion, i.e., the portion in which the image is no longer displayed by the overscanning (and the movement of the image), to the image displayed in the lower right area of the display 121 as shown in FIG. 4D (block 38).

Note that the detection of the position of the burn-in factor in each of blocks 33, 35, and 37 may be carried out in an arbitrary order, and is not subjected to time-series restriction. Also, the positions at which the factor is detected may include, for example, the center, and are not restricted to the four corners. The factor may be detected at a greater number of positions than the above-described positions as a matter of course. For example, the positions to be detected may be nine in total by including the central upper part, central lower part, left center, and right center.

When the overscanning is completed (YES in block 12), to start the pixel shift (block 14).

When the burn-in factor is no longer detected in the middle of performing the overscanning/the pixel shift (NO in block 11), justscanning is gradually performed from the present display position to which the pixel shift is applied (block 15). If the justscanning is completed (YES in block 15), since the display is returned to normal display, nothing is performed (control finished). If the justscanning is uncompleted (NO in block 15), justscanning is gradually performed from the present display position (block 39).

As described above, in the example illustrated in FIG. 7, when the processing is gradually shifted from the justscanning to the overscanning by the pixel shift, the shift is made such that the movement of the image (pixel) of the portion detected to have the burn-in factor (factor pixel) becomes large. In this way, it is possible to exhibit the pixel shift effect speedily in a portion at a high burn-in risk.

Note that the example illustrated in FIG. 7 has also been described that, of the overscanning and the pixel shift, the overscanning is first executed, and the pixel shift is executed after completion of the overscanning. However, the two may be executed alternately, or the pixel shift may be executed prior to the overscanning, for example. Further, one of the above two processes may be executed continuously for two steps or more, or both of the two may be executed for multiple steps.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the present embodiment, after reducing the horizontal display pixel number and the vertical display pixel number included in the aforementioned image signal while maintaining the ratio of the horizontal display pixel number to the vertical display pixel number, a second image signal, which provides the display size greater than or equal to the display size defined by this image signal, is generated, and at least one of output timings of a horizontal output timing and a vertical output timing of the second image signal which has been generated is changed. It should be noted that the above technology is also effective against solidification of pixels in a liquid crystal display (LCD), for example.

The present embodiment is not limited to the embodiments described above and can be modified in various manners without departing from the spirit and scope of the embodiment.

For example, the present embodiment can provide an electronic device including:

a determination module configured to determine whether an image signal which should be output to an output end includes a factor by which a pixel of a display device connected to the output end is at risk of being disabled; and

a controller configured to apply at least one of overscan and a pixel shift to the image signal determined by the determination module as including the factor such that a movement of a display position for the image signal at a portion in which the factor is detected becomes large, the overscan providing a display size greater than or equal to that defined by the image signal by removing a component of the image signal corresponding to an outer peripheral portion, the pixel shift changing at least one of output timings of a horizontal output timing and a vertical output timing of the image signal.

What is claimed is:

1. An electronic device comprising:
a determination controller configured to determine whether an image signal, which should be output to an output end, has luminance exceeding a predetermined level, and includes a specific component which is existent over a predetermined period; and
a controller configured to execute, for the image signal determined by the determination controller as including the specific component, at least one of generating a second image signal which provides a display size greater than or equal to that defined by the image signal after reducing a horizontal display pixel number and a vertical display pixel number included in the image signal while maintaining a ratio of the horizontal display pixel number to the vertical display pixel number, and changing at least one of output timings of a horizontal output timing and a vertical output timing of the image signal.

2. The electronic device of claim 1, wherein the controller changes at least one of output timings of the horizontal output timing and the vertical output timing of the image signal of the second image signal.

3. The electronic device of claim 1, wherein the controller generates the second image signal with respect to the image signal determined by the determination controller as including the specific component by reducing the horizontal display pixel number and the vertical display pixel number included in the image signal at a constant ratio for every predetermined period.

4. The electronic device of claim 1, wherein the controller changes the horizontal output timing or the vertical output timing with respect to the image signal determined by the determination controller as including the specific component at a constant ratio for every predetermined period.

5. The electronic device of claim 1, wherein the controller generates the second image signal with respect to the image signal determined by the determination controller as including the specific component by reducing the horizontal display pixel number and the vertical display pixel number included in the image signal at a constant ratio for every predetermined period, and changes the horizontal output timing or the vertical output timing at a constant ratio for every predetermined period with respect to the second image signal.

6. The electronic device of claim 1, wherein when the determination controller determines that the image signal determined by the determination controller as including the specific component no longer exists, the controller reduces a process for the image signal for generating the second image signal at a constant ratio for every predetermined period.

7. The electronic device of claim 1, further comprising a display device configured to display an image corresponding to the second image signal of the controller.

8. An electronic device comprising:
a determination controller configured to determine whether an image signal which should be output to an output end includes a factor by which a pixel of a display device connected to the output end is at risk of being disabled; and
a controller configured to execute, for the image signal determined by the determination controller as including the factor, at least one of setting an overscan mode which provides a display size greater than or equal to that defined by the image signal after removing a component of the image signal corresponding to an outer peripheral portion, and changing at least one of output timings of a horizontal output timing and a vertical output timing of the image signal.

9. A method comprising:
detecting whether an image signal, which should be output to an output end, has luminance exceeding a predetermined level, and includes a specific component which is existent over a predetermined period; and
executing, for the image signal detected as including the specific component, at least one of generating a second image signal which provides a display size greater than or equal to that defined by the image signal after reducing a horizontal display pixel number and a vertical display pixel number included in the image signal while maintaining a ratio of the horizontal display pixel number to the vertical display pixel number, and changing at least one of output timings of a horizontal output timing and a vertical output timing of the image signal.
